(19) United States
(12) Patent Application Publication
(10) Pub. No.: US 2025/0222615 A1
(43) Pub. Date: Jul. 10, 2025

(54) METHOD FOR ATTACHING AN END TERMINAL AND SPLITTING DEVICE THEREFOR

(71) Applicant: PAUGER KFT., Budapest (HU)

(72) Inventor: Dénes PAULOVITS, Budapest (HU)

(73) Assignee: PAUGER KFT., Budapest (HU)

(21) Appl. No.: 19/095,479

(22) Filed: Mar. 31, 2025

Related U.S. Application Data
(63) Continuation-in-part of application No. 18/020,600, filed on Feb. 9, 2023, now abandoned.

(30) Foreign Application Priority Data
Aug. 26, 2020 (HU) P2000280

(51) Int. Cl. B26D 7/26; B26D 7/02; F16G 11/04

(52) U.S. Cl. CPC B26D 7/2628; B26D 7/02; F16G 11/042

(57) ABSTRACT

An end terminal is attached to a pultruded solid carbon rod by first splitting an end portion of the pultruded solid carbon rod into plural, relatively smaller carbon rod portions which are then fitted into the end terminal and fixed in place by a solidifiable liquid-phase material.

### CROSS-REFERENCE TO RELATED APPLICATIONS

This application is a continuation-in-part of U.S. application Ser. No. 18/020,600, filed Feb. 9, 2023, a National Stage of PCT/HU2021/000012, filed Aug. 24, 2021, which claims priority to Hungarian Application No. P2000280, filed Aug. 26, 2020, each of which is incorporated herein in its entirety.

### TECHNICAL FIELD

The invention relates to a method for attaching an end terminal to a pultruded solid carbon rod. The invention further relates to a splitting device applicable for carrying out the method according to the invention.

### BACKGROUND

A possible process for affixing conical end terminal s to stranded steel cables, wire ropes, and Bowden cables involves separating the strands of the cable from each other, bending the strands in such a way that their configuration corresponds to the cone angle of the conical end terminal, and then filling up the space between the strands with an adhesive. For example, the socketing solution described and marketed by SocketLock works based on this principle. In itself, this technical solution has the disadvantage that the strands are connected to each other only mechanically, by a form-fitting connection, i.e., for example in the case of steel wires, the strands are wrapped together, so this solution cannot be applied with solid carbon rods.

Another prior art technical solution is described in the document WO2015071858A1 that discloses an end terminal for cables comprising high tensile-strength and high-modulus unidirectional fibers, wherein the fitting comprises two main elements: an external socket and an internal spike. Both main elements are elongated, radially symmetrical members. The socket has a tapered bore defining a tapered inner surface and the spike has a tapered outer surface that are shaped cooperatively such that when they are assembled to one another, the annular space between these surfaces is of substantially unitary cross-sectional area along their respective lengths, so that the yarns are confined along the entire length of the spike and socket.

In the case of the known technical solutions, especially in the field of application of carbon rods, the end terminal of the strands is configured such that multiple parallel strands are applied for providing a stable attachment of an end terminal. With current known solutions, a similar attachment cannot be utilized for a single pultruded solid carbon rod.

### SUMMARY OF THE INVENTION

A method for placing an end terminal on a pultruded solid carbon rod and securing it thereon in a simpler, faster, and more practical manner compared to existing methods for affixing end terminals is provided.

The method and a splitting device according to the invention are both based on the recognition that anisotropic materials, for example carbon fiber-reinforced composite materials with epoxy resin matrix can under appropriate circumstances be separated into several segments or portions by mechanical means, preferably by splitting. Such a splitting operation makes use of the low interlayer shear strength characteristic of pultruded carbon composite materials.

A method for securing an end terminal to a pultruded solid carbon rod utilizing at least the following steps:
a) providing a pultruded solid carbon rod cut to an appropriate length,
b) splitting the carbon rod along a longitudinal axis of the rod into a branched end portion of relatively smaller pultruded solid carbon rod portions or segments having a cross-sectional size smaller than 5 mm², preferably smaller than 2 mm², more preferably smaller than 1 mm², and
c) inserting the branched end portion into an end terminal, and
d) introducing a solidifiable liquid-phase material into the end terminal in an amount sufficient to fill available space within the end terminal.

In a preferred realization of the method according to the invention, step c) comprises the following steps:
pulling an end terminal onto the branched end portion such that the branched end portion preferably has a conical shape forms a substantially matching internal spatial configuration of the end terminal, and
filling up the open internal volume defined by the end terminal and the branched end portion with a liquid-phase material, for example a thermosetting adhesive, preferably a synthetic resin, and subsequently bringing about a form-fitting connection by solidifying of the liquid-phase material.

In another preferred realization of the method according to the invention:
a spike portion is inserted into the branched end portion between the split rod portions, and
applying a winding process, a form-fitting connection on the surface of the spike portion is attached around the carbon rod portions affixed to the spike portion.

In a further preferred realization of the method according to the invention, splitting of the pultruded solid carbon rod is carried out in one or more steps applying one or more adjacent blades spaced from one another.

In a further preferred embodiment of the method according to the invention, any part of the branched, preferably conical, end portion extending beyond the end terminal affixed thereon is removed.

In a preferred realization of the method according to the invention, the liquid-phase material introduced into the end terminal is a thermosetting or thermoplastic matrix material.

In a preferred embodiment of the method according to the invention, the matrix material applied in the process is an epoxy resin.

The invention further relates to a splitting device for carrying out the method according to the invention, the device comprising a centering clamp unit, a movable blade holder, and one or more blades retained in the movable blade holder, where the movable blade holder is situated opposite the centering clamp unit and is configured such that it is slidable along the longitudinal axis of a carbon rod retained in the centering clamp unit. The movable blade holder also can be rotatable about the longitudinal axis of the retained carbon rod.

### BRIEF DESCRIPTION OF THE DRAWINGS

The method according to the invention is explained below referring to the accompanying drawings, where

FIG. 1a shows the arrangement of fibers in a solid carbon rod,

FIG. 1b shows the carbon rod shown in FIG. 1a in a state wherein its end portion is split and branched,

FIGS. 2a-2d illustrates a preferred embodiment of the splitting device applied for carrying out the method, showing a preferred way of performing the splitting step according to the invention,

FIG. 3a is the sectional view of a preferred embodiment of the end terminal comprising a conical internal bore,

FIG. 3b illustrates the application of the end terminal illustrated in FIG. 3a placed on a solid carbon rod according to FIGS. 1a and 1b,

FIG. 4 illustrates an end terminal configured as a spike according to another preferred embodiment, showing the end terminal placed into the solid carbon rod of FIGS. 1a and 1b, and

FIG. 5 illustrates a plate-type end terminal according to a further preferred embodiment, showing the end terminal placed into the solid carbon rod of FIGS. 1a and 1b.

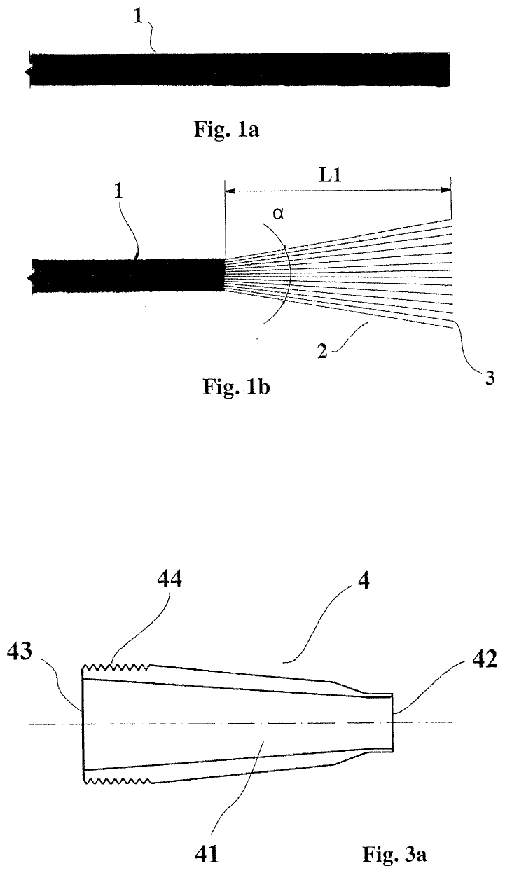

### PREFERRED EMBODIMENTS OF THE INVENTION

As the first step of the method, a pultruded solid carbon rod 1 is provided.

The chosen diameter of a pultruded solid carbon rod 1 is dependent on the loads the rod must withstand, so it can vary in accordance with the intended application. End terminals of different diameter and geometrical configuration can be affixed to pultruded solid carbon rods 1 of different thickness.

In the next step of the method, the pultruded solid carbon rod 1 is split along its longitudinal direction to provide plural, relatively smaller, pultruded carbon rod portions along the longitudinal axis of the pultruded carbon rod. Splitting can be performed in various ways.

FIG. 3a illustrates a preferred configuration of the end terminal. The end terminal 4 comprises an external threaded portion 44 adapted for connecting/retaining the fitting, and an internal hollow portion 41 that is preferably implemented as a conical bore increasing in diameter from the inset end 42 in the direction of the outset end 43. The end terminal 4 is configured such that the diameter of the inset end 42 is substantially the same (having a loose tolerance fit) as the diameter of the pultruded solid carbon rod 1, while the internal hollow portion 41 is preferably a conical portion with a cone angle of less than 10°. The exact value of the cone angle is selected to match a preferred matrix material; in the case of an exemplary epoxy resin matrix material the appropriate angle is about 4°.

The attachment of such an end terminal is illustrated in FIG. 3b. The pultruded solid carbon rod 1 is pulled through the internal hollow portion 41 of the end terminal 4 from the direction of the inset end 42 in the direction of the outset end 43, followed by carrying out the splitting steps and attaching an end terminal fitting in the open state to the free end or rod 1, thereby forming a branched, preferably conical end portion 2 of the protruded solid carbon rod 1. Thereafter, the internal hollow portion 41 of the end terminal fitting 4 is pulled on the preferably conical branched end portion 2 such that a temporary glued portion situated at the end of the end portion 2, or the temporary ring is situated outside the internal hollow portion 41 of the end terminal 4, and finally the internal hollow portion of the end terminal is filled up with a matrix material that is hardened applying a known hardening/setting method applicable for the matrix material (for example, by applying heat).

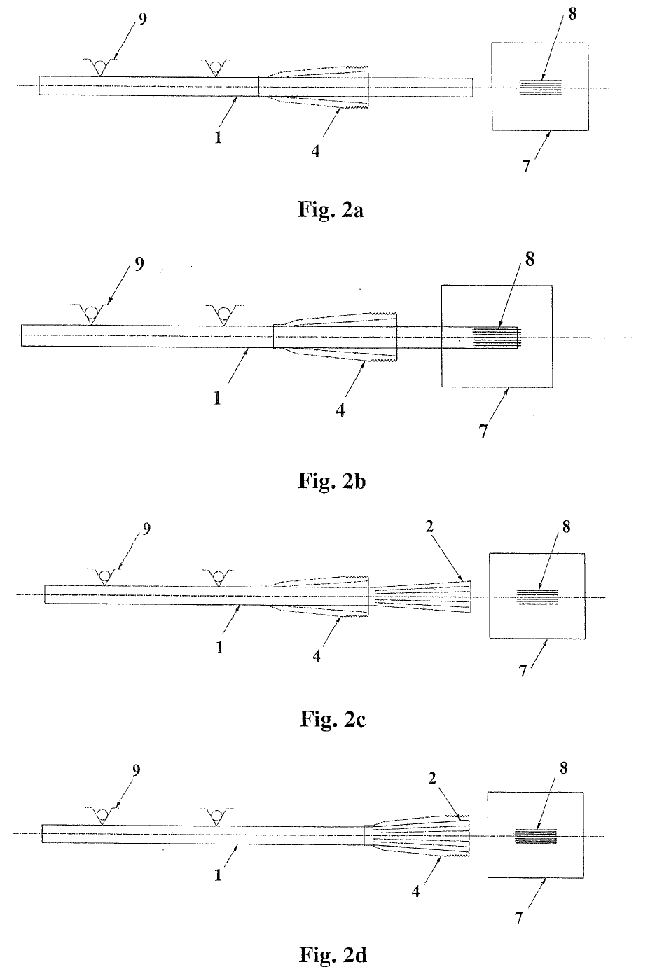

For carrying out an exemplary, preferred method a splitting device can be applied (see FIGS. 2a-2d) that comprises a centering clamp unit 9, a movable blade holder 7, and one or more spaced blades 8 retained by the one or more movable blade holders 7. The movable blade holder 7 is situated opposite the centering clamp unit 9, and is configured such that it can slide along the longitudinal axis of the pultruded solid carbon rod 1 retained in the centering clamp unit 9. This is preferably achieved, for example, by applying a system of rails or guides known per se from the technical field of turning machines for supporting the movable blade holder.

Further, the movable tool holder 7 is configured such that it can be rotated about its own axis, and thus the longitudinal axis of a held pultruded solid carbon rod, and can be stopped either at predetermined angular positions, or in certain embodiments, at a freely selectable angular position. It is thereby provided by the movable tool holder 7 that the splitting planes of the retained one or more blades 8 lie at an angle with respect to a previously applied splitting plane.

The pultruded solid carbon rod 1 is inserted and retained in the centering clamp unit 9. Thereafter, an end terminal 4 comprising a hollow portion is placed on the carbon rod 1 from the direction of the free end of the retained carbon rod 1. The carbon rod 1 is retained in the centering clamp unit 9 such that, by abutting the end terminal 4 comprising a hollow portion against the centering clamp unit 9 the rod portion extending from the end terminal 4 has at least such a length that a given split length of the rod is machinable by the movable blade holder 7. Such a retaining configuration is illustrated in FIG. 2a.

The pultruded carbon rod 1 is split along a predetermined split length L1 in its longitudinal direction (see FIG. 2b) by displacing the movable blade holder 7 dynamically or statically (applying a constant push) along the longitudinal axis of the pultruded carbon rod 1, thereby providing that the blades 8 can enter, along the given split length, the matrix material of the pultruded carbon rod 1, and between the carbon fibers forming the longitudinal strands of the pultruded carbon rod 1. After that, the movable blade holder 7 is removed from the carbon rod 1 along the axis of the retained carbon rod 1 (see FIG. 2c).

The maximum displacement of the movable blade holder 7 is set for example by applying a stop piece, but other solutions known per se, for example numeric or computer control can also be suitable for this purpose.

In the course of the method, two steps of the process can be repeated several times by rotating the movable blade holder 7 about its own axis to achieve the desired results. The movable blade holder 7 can thus be rotated about its own axis and can be fixed at selectable angular positions.

In the case of pultruded carbon rods 1 having different load bearing capacity, end terminals specially configured in different ways to match the different load values can be applied, i.e., different split patterns correspond to different-diameter pultruded carbon rods 1.

After performing the splitting step in the required manner, the rod portions 3 of the pultruded carbon rod 1 provided by the splitting step are secured in a space-apart position. The portions can be spaced apart from each other for example by applying a conical spike that is inserted into the movable blade holder 7 substituting the blades, such that the relatively smaller rod portions 3 spaced apart by the spike in a uniform manner are secured with respect to each other applying temporary adhesive bonding.

In the subsequent step of the method (see FIG. 2d) the end terminal 4 is pulled on the end portion 2 formed in this way.

In the course of the method, splitting must be carried out such that the cross-sectional area of the individual split, relatively smaller rod portions 3 is small enough to allow that the portions can be appropriately bent for providing a uniform arrangement thereof in the end terminal 4. The cross-sectional size of the smaller rod portions 3 obtained by splitting is therefore expediently not greater than 5 mm², preferably not greater than 2 mm², more preferably not greater than 1 mm².

As an example, the splitting process of a specific solid carbon rod 1 with a diameter of 7 mm will be described. In this case, a splitting device consisting of five blades spaced apart uniformly along the width (7 mm) of the device can be applied for carrying out the splitting process in four steps. Between the four splitting steps, the splitting device is rotated substantially by 45° or by a multiple of 45° corresponding to the pattern. In the case of the pattern obtained this way, rod portions 3 with different cross-sectional size, but with a cross-sectional size that is uniformly smaller than 1 mm², are formed.

It is to be noted that, in the process carried out according to the exemplary method the degree of rotation of the splitting device, the number of splitting steps, and the configuration of the splitting device are not restricted to the parameters set forth in the exemplary embodiment. i.e., this step of the method can also be carried out applying different settings.

In FIG. 3b, the angle of the conical wall of the internal hollow portion 41 is configured to correspond to the matrix material applied for the method, thus ensuring an appropriate bonding. The inside cone angle is preferably between 1-10°; in the case of the epoxy resin applied in a preferred embodiment it is for example preferably 4°.

In the case of an end terminal 4 according to FIGS. 3a and 3b, if the required bonding length is known, then the other parameters of the inside cone of the end terminal can be determined in a manner known to a person skilled in the art based on the diameter of the applied solid carbon rod 1 and the cone angle.

Although FIGS. 3a and 3b illustrate a preferred embodiment of the end terminal 4 wherein the internal hollow portion 41 has a conical configuration, the method can also be applied with end terminals that are configured differently. It is for example conceivable that the internal opening into which the split end portion 2 is inserted has a different geometrical configuration that provides an appropriate form-fitting and/or frictional connection.

After splitting, the individual relatively smaller pultruded solid carbon rod portions 3 are spaced apart from each other in the radial direction of the cross-section of the carbon rod 1, thereby providing a branched, preferably conical geometrical configuration at the end of the carbon rod 1.

The conical geometry is preferably formed applying a conical spike that is inserted (driven) between the split rod portions 3 in a centered manner in the axial direction of the carbon rod 1. As the conical spike is inserted in a centered manner, the split-up rod portions 3 are bent outward uniformly along the cone. The uniformly bent rod portions must be bent outwardly such that they diverge at a given cone angle α inside the cone of the end terminal to be applied. For example, for the end terminal having an inside cone angle of 4° mentioned above, this implies a maximum cone angle of 4°. Because an accurate fit is not required, and because the rod portions 3 are not completely straight when they are bent outward, the cone angle α of the rod portions 3 will typically only approximately be the same as the cone angle of the internal cone.

After forming the outward bend of the carbon rod portions 3, the carbon rod portions 3 are fixed in their specified position, followed by removing the conical spike. A preferred solution for fixing the rod portions is applying adhesive to the ends of the branched, preferably conical end portion 2. After the adhesive has dried, it temporarily keeps the carbon rod portions 3 in the desired position relative to each other.

The cone angle can also be formed by other means, for example by inserting a spacer ring or other spacer member with holes, or by inserting a wedge-like internal cone member between the carbon rod portions 3 (which wedge-like cone member will then stay between the rod portions).

The temporarily fixed branched (preferably conical) end portion 2 is arranged in a corresponding internal cavity, preferably a bore, of an end terminal, filling up the remaining free spaces with a matrix material.

The empty spatial regions between the carbon rod portions arranged inside the internal hollow portion can be filled up for example making use of gravity (by arranging the end terminal vertically) and also by high-pressure injection.

Thereafter, in case the split-up carbon rod portions extend over the conical portion of the end terminal, the overextending portions are removed. The carbon rod portions can be removed applying a process known per se, for example cutting.

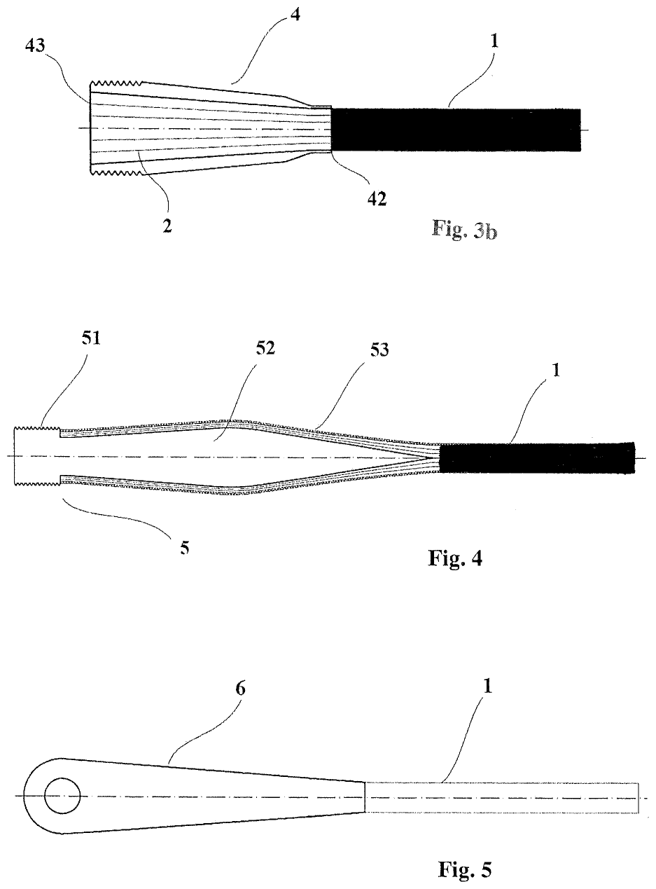

FIG. 4 illustrates an end terminal 5 configuration applicable with another method. The end terminal 5 illustrated in FIG. 3 comprises a threaded portion 51 and a spike portion 52. In the case of an end terminal shown in FIG. 3, the method according to the invention can be applied such that the end terminal is inserted into the split-up, branched end portion 3 of the split pultruded solid carbon rod 1. The end terminal is secured by applying a matrix material that provides an adhesive bond around the spike portion 52. To provide a secure attachment, an outer jacket 53 is formed by a winding process around the carbon rod portions 3 of the split-up carbon rod 1 applying, for example, heat-shrink braids that compress the carbon rod portions between which the matrix material is in a cross-linked state after the shrinking process.

FIG. 5 illustrates an end terminal 6 configuration applicable with a further method. In this case, the end terminal 6 is assembled from end terminal plates 6′ by making parallel cuts in the solid carbon rod 1 simultaneously or successively in order to increase the adhesion surface area for the plates, inserting the end terminal plates 6′ into the cuts, and securing them therein by adhesive bonding.

To provide a secure attachment, the relatively smaller carbon rod portions 3 of the split-up carbon rod 1 are optionally compressed by a winding process, applying for example heat-shrink braids that compress the carbon rod portions between which the matrix material is in a cross-linked state after the shrinking process.

The material applied for final bonding can for example be the same synthetic resin, preferably epoxy resin that constitutes the matrix material of the carbon rod 1, but other matrix materials with suitable technical parameters can also be applied. The liquid-phase thermosetting adhesive is solidified applying a suitable heat treatment, thereby providing a form-fitting connection and/or an adhesive bonding for the conical end terminal.

A great advantage of the method is that an end terminal can be applied to a pultruded solid carbon rod 1 (instead of a cable with multiple parallel strands), so for the same tensile strength the total cross-sectional area is reduced, or a higher tensile strength can be achieved with the same cross-sectional area in the case of tensile-loaded unidirectional fibers.

Another advantage of the method with respect to existing solutions is that pultruded solid carbon rods can be prefabricated in different diameters such that the end terminals that are required for their application can be attached post-manufacturing. This characteristic of the method provides great manufacturing flexibility.

The pultruded solid carbon rods made in this manner have a greater carbon fiber content compared to the fiber-containing cables applied in prior art technical solutions, and thus the technical parameters of the carbon rod provided with the end terminal are improved compared to the rods provided with end terminals according to existing technical solutions.

A further advantage of the present method is that it provides a new mode for affixing an end terminal that is speedier than the existing technical solutions, and has more favorable technical parameters from the aspect of the end product.

### LIST OF REFERENCE NUMERALS

1—carbon rod
2—end portion
3—rod portion
4—end terminal
41—internal hollow portion
42—inset end
43—outset end
44—external threaded portion
5—end terminal
51—threaded portion
52—spike portion
53—outer jacket
6—end terminal plate
7—movable blade holder
8—blade
9—centering clamp unit
α—cone angle
L1—split length

1. Method for securing an end terminal to a pultruded solid carbon rod which comprises:
a) providing a pultruded solid carbon rod;
b) splitting a predetermined length end portion of the pultruded solid carbon rod along a longitudinal axis of the pultruded solid carbon rod into a branched end portion thereof constituted by relatively smaller pultruded solid carbon rod portions, each said pultruded solid carbon rod portion having a cross-sectional size of less than 5 mm²;
c) inserting said branched end portion into an end terminal; and
d) introducing a solidifiable liquid-phase material into the end terminal in an amount sufficient to fill available space within the end terminal.

2. The method according to claim 1, wherein the splitting is carried out using spaced blades.

3. The method according to claim 1, wherein following step c), part of the branched end portion extending over the end terminal affixed thereon is removed.

4. The method according to claim 1, wherein the liquid-phase material is a thermoplastic.

5. The method according to claim 1, wherein the liquid-phase material is an epoxy resin.

6. The method according to claim 1, wherein said cross-sectional size is less than 2 mm².

7. The method according to claim 1, wherein the cross-sectional size is less than 1 mm².

8. The method according to claim 1, wherein the liquid-phase material is a thermosetting adhesive.

9. The method according to claim 1, wherein the liquid-phase material is a synthetic resin.

10. A splitting device suitable for splitting an end portion of a pultruded solid carbon rod comprising a centering clamp unit adapted to hold the pultruded solid carbon rod, a movable blade holder with spaced blades retained in the movable blade holder, the movable blade holder being situated opposite the centering clamp unit, being slidable along a longitudinal axis of said pultruded solid carbon rod when held in said centering clamp unit, and rotatable about said longitudinal axis.
